(19) United States
(12) Patent Application Publication
(10) Pub. No.: US 2026/0333124 A1
(43) Pub. Date: Oct. 22, 2026

(54) SYSTEMS AND METHODS FOR DYNAMIC LINK CAPACITY ESTIMATION OF A WIRELESS COMMUNICATION LINK

(71) Applicant: NETWORK ACCESS ASSOCIATES LIMITED, London (GB)

(72) Inventors: Joseph BOONE, Fairfax, VA (US); James CRAVEN, Columbia, MD (US); Asanga WEDISINGHE, Arlington, VA (US)

(21) Appl. No.: 19/180,478

(22) Filed: Apr. 16, 2025

(51) Int. Cl. H04W 28/06; H04B 17/309; H04L 47/127; H04W 84/06

(52) U.S. Cl. CPC H04W 28/06; H04B 17/346; H04L 47/127; H04W 84/06

(57) ABSTRACT

Systems and methods include dynamic link capacity estimation in wireless communication links, wherein the technical problem addressed comprises fluctuating conditions in wireless networks, such as those encountered in wireless networks, which affect link performance. In one embodiment, the present system provides a solution by employing real-time monitoring of link characteristics in conjunction with predictive models to estimate link capacity based on current link states, wherein the estimation enables adaptive management of data flow. Accordingly, the system includes a processor (100) and a predictive model (104) to control queued communications in accordance with the capacity estimates, thereby ensuring efficient data transmission and enhancing service quality.

### FIELD OF TECHNOLOGY

The present disclosure generally relates to systems and methods for dynamic link capacity estimation in wireless communication links, specifically within the realm of wireless communication technologies.

### BACKGROUND

Unlike traditional terrestrial and satellite communication networks, such as cellular networks and networks that rely on geosynchronous (GEO) satellites to connect with remote earth stations, emerging low earth orbit (LEO)/medium earth orbit (MEO) satellite networks, high altitude platform networks and other wireless communication network using mobile transmission relays pose unique challenges due to the dynamic nature of the link between the ground station and the serving relay. In these networks, factors such as latency and available bandwidth fluctuate constantly and often periodically due to varying channel parameters such as slant range, terminal performance, and relay performance.

### SUMMARY

In some aspects, the techniques described herein relate to a method including: monitoring, by at least one processor, in real-time, at least one monitored wireless communication link characteristic associated with a wireless communication link between at least one communication device and at least one remote communication device; wherein the at least one monitored wireless communication link characteristic includes at least one performance affecting measurement associated with a performance of the wireless communication link; determining, by the at least one processor, in real-time, based at least in part on the at least one monitored wireless communication link characteristic, at least one link state associated with the wireless communication link; inputting, by the at least one processor, in real-time, the at least one link state into at least one predictive capacity estimation model to output a dynamic link capacity estimate representative of a link state-dependent data capacity of the wireless communication link; wherein the link state-dependent data capacity is indicative of a quantity of data the wireless communication link is estimated to be capable of carrying based on the at least one link state; wherein the at least one predictive model models a link capacity response resulting from the at least one wireless communication link characteristic; wherein the at least one predictive model is based at least in part on model link capacity data; and controlling, by the at least one processor, a queue of queued wireless communications based at least in part on the link capacity estimate to optimize use of the wireless communication link.

In some aspects, the techniques described herein relate to a system including: at least one processor associated with at least one communication device; and at least one non-transitory computer-readable medium having software instructions stored thereon; wherein the at least one processor, upon execution of the software instructions, is configured to: monitor, in real-time, at least one monitored wireless communication link characteristic associated with a wireless communication link between the at least one communication device and at least one remote communication device; wherein the at least one monitored wireless communication link characteristic includes at least one performance affecting measurement associated with a performance of the wireless communication link; determine, in real-time, based at least in part on the at least one monitored wireless communication link characteristic, at least one link state associated with the wireless communication link; input, in real-time, the at least one link state into at least one predictive capacity estimation model to output a dynamic link capacity estimate representative of a link state-dependent data capacity of the wireless communication link; wherein the link state-dependent data capacity is indicative of a quantity of data the wireless communication link is estimated to be capable of carrying based on the at least one link state; wherein the at least one predictive model models a link capacity response resulting from the at least one wireless communication link characteristic; wherein the at least one predictive model is based at least in part on model link capacity data; and control a queue of queued wireless communications based at least in part on the link capacity estimate to optimize use of the wireless communication link.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram illustrating the system for dynamic link estimation in a wireless communication environment in accordance with one or more embodiments of the present disclosure.

FIG. 2 is a block diagram illustrating the process of generating the Link State through monitoring and determination of link state characteristics in a wireless communication system in accordance with one or more embodiments of the present disclosure.

FIG. 3 is a block diagram illustrating the process of dynamic link estimation using network and capacity models in accordance with one or more embodiments of the present disclosure.

FIG. 4 is a block diagram illustrating the process of generating predictive models for dynamic link capacity estimation in satellite communication networks in accordance with one or more embodiments of the present disclosure.

FIG. 5 is a schematic block diagram illustrating the system for managing data transmission over a wireless communication link using predicted capacity estimates in accordance with one or more embodiments of the present disclosure.

FIG. 6 depicts a block diagram of another exemplary computer-based system and platform for dynamic link estimation in accordance with one or more embodiments of the present disclosure.

FIG. 7 depicts an illustrative plot of time-dependent behavior of instantaneous and averaged bandwidth for a LEO satellite link in accordance with one or more embodiments of the present disclosure.

### DETAILED DESCRIPTION

In the realm of wireless communication technologies, the ability to accurately estimate the capacity of a communication link plays a significant role in optimizing data transmission and ensuring efficient use of available bandwidth. Wireless communication links, such as those used in mobile networks and satellite communications, often experience fluctuating conditions due to various factors including environmental changes, mobility of devices, and interference from other signals. These fluctuations can lead to unpredictable variations in link performance, affecting the quality of service and user experience.

Traditional methods for estimating link capacity typically rely on static models that do not account for real-time variations in link characteristics. These methods often use fixed parameters and historical data to predict link capacity, which can result in inaccurate estimations when the link conditions change rapidly. As a result, static estimation methods may lead to inefficient resource allocation, increased latency, and potential congestion in the network, as they fail to adapt to the dynamic nature of wireless communication environments.

The present disclosure addresses these challenges by introducing systems and methods for dynamic link capacity estimation in wireless communication links. Unlike previous approaches, this system leverages real-time monitoring of link characteristics and employs predictive models to estimate link capacity based on current link states to model link state-dependent data capacity of a wireless communication link. By continuously assessing the performance characteristics of the communication link, the system enables adaptive management of data flow, optimizing the use of the link and enhancing the overall quality of service. The use of predictive capacity estimation models, which may include machine learning algorithms or correlation functions, allows for accurate forecasting of link capacity, accommodating the dynamic and unpredictable nature of wireless communication environments.

Embodiments herein include systems and methods for dynamically estimating the capacity of a wireless communication link in real-time. This method involves monitoring wireless communication link characteristics, determining link states, and using predictive models to estimate link capacity. By controlling a queue of wireless communications based on this estimate, the method optimizes the use of the communication link.

The operational principle of this method lies in the ability to adaptively manage data flow over a wireless communication link by continuously assessing the link's performance characteristics. Real-time monitoring and estimation enable a more efficient allocation of resources, reducing latency and improving data throughput. The method's novelty is highlighted by the use of predictive capacity estimation models, which can include machine learning algorithms or correlation functions, to forecast link capacity based on current link states. This approach contrasts with traditional static methods that do not account for real-time variations in link performance.

The practical application of this method is evident in scenarios where wireless communication links experience fluctuating conditions, such as in mobile networks or satellite communications. By dynamically adjusting the data flow based on real-time capacity estimates, the method ensures optimal utilization of the available bandwidth, thereby enhancing the overall quality of service. For example, in a mobile network, this method can prevent congestion by adjusting the data transmission rate according to the current link capacity, leading to a smoother user experience.

Furthermore, the method's ability to incorporate both historical and simulated link capacity data into predictive models provides a robust framework for capacity estimation, accommodating a wide range of operational environments and conditions. This adaptability makes the method particularly advantageous in complex communication systems where link conditions can change rapidly and unpredictably.

Inventors appreciate that the dynamic approach described herein to estimating link capacity in periodically varying satellite communication links, particularly within LEO/MEO satellite networks, unlike traditional methods that rely on static parameters, utilizes a predictive model and algorithm to estimate link capacity based on real-time state information and historical data. The system continuously adjusts the uplink rate to at or below the estimated capacity, allowing for effective active queue management and prioritization of traffic types, such as voice calls over web browsing. This approach not only enhances user Quality of Experience by maintaining low latency and minimal jitter but also adapts to different user terminal capabilities and potential external factors like weather. The system's ability to operate without direct capacity measurement and its integration of both passive and active characteristics for link estimation further distinguish it from existing technologies.

In the context of wireless communication, “link state” refers to the current condition or status of a communication link, characterized by various performance metrics such as signal strength, interference levels, signal-to-noise (SNR), signal-and-interference-to-noise (SNIR), latency, and bandwidth availability. It provides a snapshot of the link's operational environment, which can be used to assess and predict the link's capacity to carry data effectively.

Queue management refers to the process of organizing and controlling the flow of data or tasks in a queue to optimize performance and resource utilization. In the context of wireless communication, it involves managing the sequence and timing of data packets being transmitted over a communication link, ensuring efficient use of bandwidth and minimizing latency. Effective queue management can prevent congestion and improve the overall quality of service by dynamically adjusting the data flow based on real-time conditions.

In the context of wireless communication, “capacity” refers to the maximum amount of data that can be transmitted over a communication link within a given time period. It is a measure of the link's ability to carry data effectively, influenced by factors such as bandwidth, signal quality, and network conditions. Capacity is a critical parameter in determining the efficiency and performance of a communication system, impacting the quality of service and user experience.

Latency refers to the time delay between the initiation of a process or request and its completion or response. In the context of wireless communication, it is the time taken for a data packet to travel from the source to the destination across a network. Lower latency is generally desirable as it indicates a more responsive and efficient communication link.

A communication link refers to a connection established between two or more communication devices that enables the transfer of data or information. It can be wired or wireless and is characterized by various parameters such as bandwidth, latency, and signal quality, which determine the efficiency and reliability of data transmission across the link.

In one embodiment, the system for dynamic link capacity estimation can be implemented in a terrestrial network environment where the communication device is a ground-based user terminal interfacing with a satellite. The processor monitors passive characteristics such as signal-to-interference-and-noise ratio (SINR) and elevation angle, which are important for determining the link state. In another embodiment, the system can be adapted for use in a maritime environment, where the communication device is installed on a ship, and the monitored characteristics include additional parameters like sea state or weather conditions, which can affect signal propagation. The predictive capacity estimation model can be configured to utilize historical data specific to maritime conditions to enhance accuracy. In yet another embodiment, the system can be integrated into an aerial platform, such as an aircraft, where the communication device monitors characteristics like altitude and speed, which influence the link state. The predictive model can incorporate machine learning techniques to dynamically adjust to rapid changes in these parameters. Additionally, the system can be configured to operate in a hybrid network environment, where both terrestrial and non-terrestrial communication devices are involved, allowing for seamless transition and optimization of link capacity across different communication mediums. Each embodiment maintains the fundamental functionality of real-time monitoring, link state determination, and dynamic capacity estimation, ensuring optimal use of the wireless communication link.

In one embodiment, the wireless communication link comprises an uplink, where data is transmitted from a user terminal on Earth to a satellite in orbit. This configuration is particularly useful for applications requiring data to be sent from remote locations to centralized data processing centers, such as telemetry data from scientific instruments or communication from mobile units like ships or aircraft. In another embodiment, the wireless communication link comprises a downlink, where data is transmitted from the satellite to the user terminal. This setup is ideal for delivering content or data to end-users, such as streaming services or internet access in remote areas. A further embodiment includes both uplink and downlink capabilities, allowing for bidirectional communication between the user terminal and the satellite. This dual-link configuration supports more complex applications, such as interactive services or real-time data exchange, where both sending and receiving data are important. The system can be adapted to various satellite network topologies, including hub-and-spoke or mesh networks, and can operate across different frequency bands, such as Ka-band or Ku-band, to optimize performance based on specific environmental conditions or regulatory requirements. Additionally, the system can be implemented using different types of satellites, including geostationary, medium Earth orbit (MEO), or low Earth orbit (LEO) satellites, each offering distinct advantages in terms of coverage area, latency, and bandwidth availability.

In one embodiment, the non-terrestrial communication device is a satellite operating in a low Earth orbit (LEO), which facilitates communication with remote earth stations by dynamically adjusting link capacity based on real-time estimations. This embodiment leverages the satellite's ability to provide high-speed data transmission with minimal latency, making the satellite suitable for applications such as broadband internet access in remote areas. In another embodiment, the non-terrestrial communication device could be a high-altitude platform station (HAPS), such as an unmanned aerial vehicle (UAV) or balloon, which hovers in the stratosphere to provide a stable communication link. This configuration is particularly advantageous for temporary or emergency communication setups where rapid deployment is necessary. Additionally, the system could be implemented in a geostationary satellite, which, despite its higher latency compared to LEO satellites, offers a constant position relative to the earth, making the geostationary satellite ideal for consistent coverage over a specific geographic area. Each of these embodiments utilizes the fundamental technology of dynamic link capacity estimation to optimize communication efficiency and quality, adapting to the distinct characteristics and operational environments of the respective non-terrestrial communication devices.

In one embodiment, the system for determining link state characteristics includes a processor configured to transmit a probe signal over a wireless communication link, where the probe signal is a simple ping or a more complex packet designed to measure latency and other characteristics. The processor measures the response time of the probe signal to determine latency, which is a probed wireless communication link characteristic. In another embodiment, the system utilizes a series of probe signals sent at varying intervals to assess changes in latency over time, providing a dynamic view of the link's performance. This approach can be particularly useful in environments where link conditions fluctuate rapidly, such as in low Earth orbit (LEO) satellite communications. Additionally, the system may incorporate a machine learning model that analyzes the probed characteristics alongside passive characteristics, such as signal-to-interference-and-noise ratio (SINR) and elevation, to refine the link state determination. In yet another embodiment, the system could be integrated into a satellite ground station, where the system continuously monitors both passive and active link characteristics to optimize data throughput and minimize latency. This integration allows for real-time adjustments to the communication link, ensuring efficient data transmission even under varying environmental conditions.

In one embodiment, the system measures latency as a probed wireless communication link characteristic by sending a single probe signal, such as a ping, and recording the round-trip time to determine the latency of the link. This method provides a straightforward approach to assessing latency in relatively stable environments where link conditions do not fluctuate rapidly.

In another embodiment, the system employs a more sophisticated approach by sending multiple probe signals at different intervals to capture variations in latency over time. This method is particularly beneficial in dynamic environments, such as those involving low Earth orbit (LEO) satellites, where link conditions can change quickly. By analyzing the collected data, the system can provide a more comprehensive view of latency trends and fluctuations.

Additionally, the system may incorporate active latency measurements into a broader framework that includes passive characteristics like signal-to-interference-and-noise ratio (SINR). By combining these data points, the system can refine its understanding of the link state and make more accurate predictions about future link performance.

In yet another embodiment, the system could be integrated into a network management platform that continuously monitors both active and passive link characteristics. This integration allows for real-time adjustments to the communication link, optimizing data throughput and minimizing latency even in challenging conditions, such as those encountered in satellite communications or mobile networks.

In various embodiments, the predictive model used for dynamic link capacity estimation can be implemented using different techniques and configurations to adapt to diverse operational environments and requirements. One embodiment involves utilizing a correlation function derived from historical data, where the model analyzes past link performance metrics such as signal-to-interference-and-noise ratio (SINR) and user terminal elevation to predict future link capacity. This approach can be particularly effective in environments where historical data is abundant and reliable. Another embodiment employs a machine learning model, which can be trained using both historical and simulated data to recognize complex patterns and relationships within the link characteristics. This machine learning model can be configured to continuously learn and adapt to new data inputs, making it suitable for dynamic and rapidly changing satellite communication environments. Additionally, the machine learning model can be implemented using various algorithms, such as neural networks or decision trees, depending on the specific requirements of the communication system. These models can be deployed on different hardware platforms, ranging from dedicated servers to cloud-based systems, allowing for scalability and flexibility in processing capacity. Furthermore, the predictive model can be integrated with real-time data inputs, such as active latency measurements, to refine predictions and enhance the accuracy of the link capacity estimation. This integration can be achieved through modular software architecture, enabling easy updates and modifications to the model as new data becomes available or as system requirements evolve. Each embodiment ensures that the predictive model remains within the scope of the described technology by focusing on estimating link capacity based on passive and active characteristics, thereby optimizing the use of the wireless communication link.

In one embodiment, the model link data used in the predictive capacity estimation model comprises historical link capacity data, which is collected over time from previous communication sessions. This data can include metrics such as past bandwidth usage, latency, and error rates, allowing the system to identify patterns and trends that inform future capacity predictions. In another embodiment, the model link data is derived from simulated link capacity data, which involves creating virtual models of the communication environment to predict how different variables might affect link capacity. This simulation can account for various factors such as satellite positions, weather conditions, and user terminal performance, providing a comprehensive dataset for capacity estimation. Additionally, the system can be configured to use a combination of both historical and simulated data, leveraging the strengths of each to enhance prediction accuracy. This hybrid approach allows the system to adapt to real-time changes while maintaining a robust understanding of potential future states. Furthermore, the model link data can be updated dynamically, incorporating new historical data and refined simulations to continuously improve the predictive model's accuracy and reliability. These embodiments demonstrate the system's adaptability in utilizing diverse data sources to optimize link capacity estimation.

In one embodiment, the system for predicting return link capacity over a wireless communication link can be implemented using a combination of passive and active measurement techniques. The passive measurements might include monitoring the signal-to-interference-and-noise ratio (SINR) and the elevation angle of the user terminal, which are used to estimate the link state without actively probing the network. In another embodiment, the system could incorporate active measurements, such as sending probe signals to measure latency, which can provide additional data to refine the capacity estimation. The predictive capacity estimation model could be based on historical data, simulated data, or a combination of both, allowing for flexibility in adapting to different network conditions and user terminal capabilities. The model might employ machine learning algorithms to dynamically adjust predictions based on real-time data inputs, enhancing the accuracy of the capacity estimate. Furthermore, the system could be deployed in various configurations, such as being integrated into the user terminal, located at a central hub, or distributed across multiple network nodes, depending on the specific requirements of the satellite communication network. This adaptability ensures that the system can be tailored to optimize performance across different satellite constellations and user scenarios, maintaining efficient data transmission and minimizing latency and jitter.

In one embodiment, the monitored wireless communication link characteristic includes the slant range, which can be determined by the angle between the communication device and the satellite, affecting the signal path length and thus the link performance. This embodiment can be implemented using a variety of sensors or algorithms to calculate the slant range based on the satellite's position and the terminal's location. In another embodiment, the communication device elevation is monitored, which involves measuring the angle of the device's antenna relative to the horizon. This can be achieved using gyroscopic sensors or GPS data to adjust the antenna's orientation for optimal signal reception. Additionally, the communication device performance can be assessed by monitoring the signal-to-interference-and-noise ratio (SINR), which provides a measure of signal quality and can be used to adjust transmission power or modulation schemes to maintain link quality. This embodiment may utilize advanced signal processing techniques to continuously evaluate SINR and adapt the communication parameters accordingly. Each of these embodiments allows for the dynamic adjustment of the communication link's parameters to optimize performance under varying environmental and operational conditions, ensuring robust and efficient data transmission.

In various embodiments, the system for monitoring wireless communication link characteristics can be adapted to utilize different types of communication devices and configurations to assess signal-to-interference-and-noise ratio (SINR). One embodiment may involve a satellite communication system where the user terminal is equipped with advanced signal processing capabilities to measure SINR directly from the satellite link, allowing for real-time adjustments to link capacity estimates. Another embodiment could employ terrestrial communication devices, such as cellular towers, which use SINR measurements to optimize data throughput in densely populated urban areas. Additionally, the system could be configured to operate in hybrid networks, combining satellite and terrestrial links, where SINR is measured across both types of connections to provide a comprehensive link capacity estimate. The communication devices may vary in size and complexity, ranging from small handheld devices to large ground stations, each tailored to specific operational environments and requirements. Furthermore, the system could incorporate different materials and technologies, such as advanced antenna designs or signal processing algorithms, to enhance SINR measurement accuracy and reliability. These embodiments demonstrate the system's adaptability to different communication environments and technologies while maintaining the fundamental functionality of monitoring SINR to optimize link capacity.

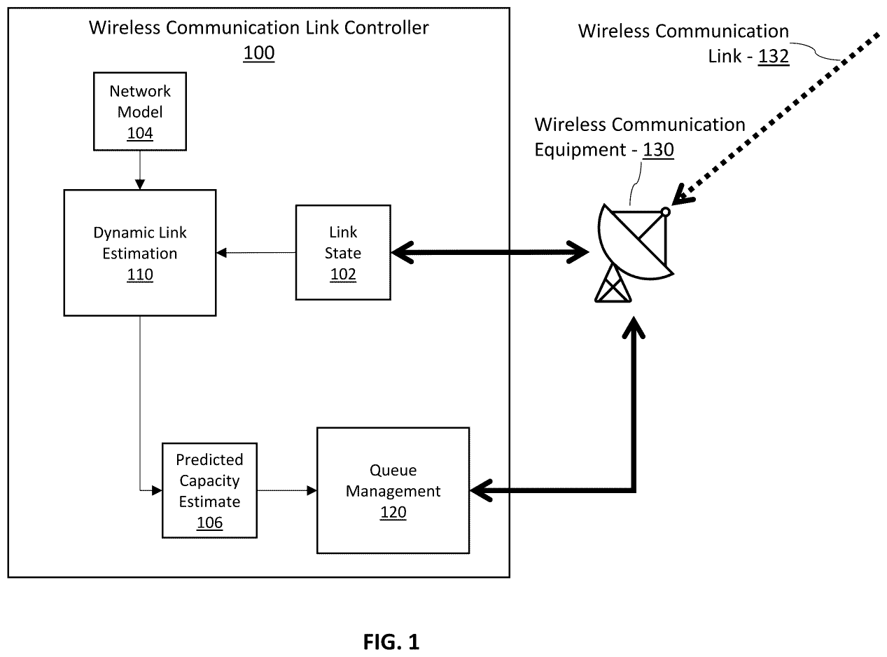

Referring now to FIG. 1, a system is shown for dynamic link estimation in a wireless communication environment, which is designed to optimize the transmission of data over a Wireless Communication Link 132. The system is centered around a Wireless Communication Link Controller 100, which orchestrates the estimation and management of link capacity.

In some embodiments, a wireless network, such as a satellite network, cellular network, among others, can structured in a hub-and-spoke topology where multiple remote stations (the spokes) connect to central communication equipment situated at a hub. This hub can be linked to both private and public networks, including the Internet. This design facilitates efficient communication and management by connecting remote locations to centralized infrastructure, such as servers and public and/or private networks, while also enabling direct communication among the spokes via the hub. By centralizing control and resources, the hub-and-spoke topology enhances data transmission efficiency and simplifies network management. This makes it particularly well-suited for applications like rural broadband connectivity, cellular backhaul, and mobility services such as providing Internet access on airplanes or cruise ships that cannot rely on land-based telecommunications.

The Wireless Communication Link Controller 100 integrates several important components to achieve Dynamic Link Estimation 110. The Link State 102 is an input that represents the current conditions and characteristics of the Wireless Communication Link 132. This information can be used for understanding the real-time performance and potential limitations of the link. The Dynamic Link Estimation 110 utilizes both the Link State 102 and the Network Model 104 to generate a Predicted Capacity Estimate 106. This estimate reflects the anticipated data capacity of the Wireless Communication Link 132, allowing for proactive adjustments to optimize data transmission.

The Dynamic Link Estimation 110 can resides in the remote station but may optionally have components that reside in an external device and/or within the customer network. The Dynamic Link Estimation 110 can determine a real-time estimate of the link's available capacity (the Predicted Capacity Estimate 106) which it can use as a limiting constraint on the Queue Management 120. The Dynamic Link Estimation 110 can use current state information from a communication terminal along with the available predictive models (the Network Model 104) and may also optionally use the real-time active latency measurements if available.

In various embodiments, the Link State 102, which serves as an input representing the current conditions and characteristics of the Wireless Communication Link 132, can be derived from a multitude of parameters and configurations. For instance, the Link State 102 may include passive characteristics such as the signal-to-interference-and-noise ratio (SINR) and the elevation angle of the user terminal, which are influenced by external environmental factors. These parameters can be gathered without active probing, allowing for a non-intrusive assessment of the link's condition. In another embodiment, the Link State 102 might incorporate active measurements, such as latency, obtained through intentional probing techniques like over-the-air pings. This approach can provide a more comprehensive understanding of the link's performance by combining both passive and active data. Additionally, the Link State 102 can be tailored to account for specific user terminal capabilities, which may vary based on the terminal's hardware and software configurations. This adaptability ensures that the system can optimize link capacity estimation across different terminal types and operational environments. Furthermore, the Link State 102 can be dynamically updated to reflect real-time changes in the link's conditions, enabling the system to continuously adjust its capacity estimation and queue management strategies to maintain optimal performance. These embodiments highlight the flexibility and robustness of the system in adapting to diverse communication scenarios while remaining within the scope of the described technology.

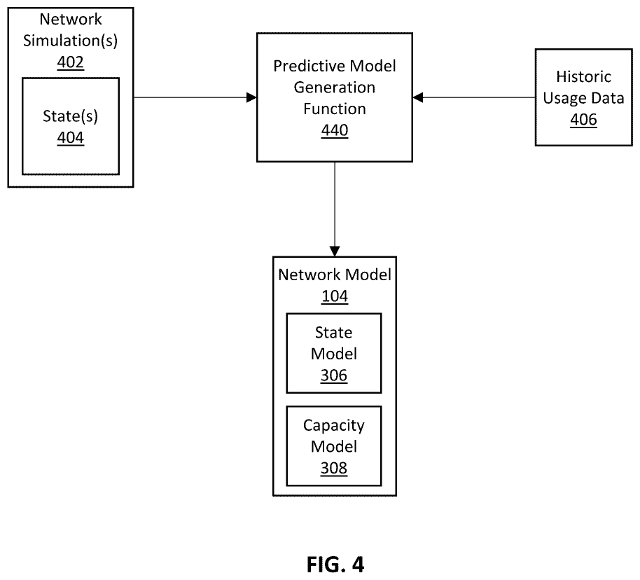

The Network Model 104 is a component that provides a model of the behavior of the Wireless Communication Link 132 under different conditions. This model can include historical data, simulated scenarios, or machine learning techniques to improve the accuracy of predictions. In various embodiments, the Network Model 104 may utilize historical data to predict link behavior based on past performance metrics and trends. This historical data can include previous link capacity measurements, environmental conditions, and user terminal performance, providing a comprehensive basis for forecasting. A Predictive Model Generation Function may reside within an Operational Support System (OSS) component of the communication network. It is a function that is not directly in the data path, but instead produces the network model 104 (see, FIG. 4 below) used by the Dynamic Link Estimation 110 to accurately assess the current link capacity available to the remote station. The Predictive Model Generation Function uses network simulations of both idealized and actual networks including detailed satellite constellation state along with applicable historical usage data.

In some embodiments, the Network Model 104 may employ simulated scenarios. These simulations can replicate different environmental conditions, user behaviors, and network configurations to predict how the Wireless Communication Link 132 might perform under such circumstances. This approach allows for the exploration of potential link behaviors that have not been observed in real-world data, offering a broader understanding of possible outcomes.

In some embodiments, the Network Model 104 may incorporate machine learning techniques to improve prediction accuracy. Machine learning models used for predicting a capacity estimate can include any one or more in a range of types, each offering unique advantages depending on the specific requirements and characteristics of the wireless communication environment, such as regression models, decision trees, random forests, support vector machines (SVM), neural network (e.g., recurrent neural networks (RNN)), Bayesian networks, ensemble methods, among others or any combination thereof.

In some embodiments, Regression Models, such as linear regression or polynomial regression, can be used to predict continuous values, and thus may be used for estimating link capacity metrics (e.g., bandwidth, or other performance metrics) based on historical data trends and real-time inputs.

In some embodiments, Decision Trees can be employed to make predictions based on a series of decision rules derived from training data. Decision trees may be particularly useful for complex datasets with multiple variables influencing link capacity.

In some embodiments, Random Forests are an ensemble learning method that combine multiple decision trees to improve prediction accuracy and robustness. This approach can be beneficial for capturing intricate patterns in the data that affect link capacity.

In some embodiments, Support Vector Machines (SVM) can be used for regression tasks, providing a way to predict link capacity by finding the optimal hyperplane that best fits the data. They are effective in high-dimensional spaces and can handle non-linear relationships.

In some embodiments, Neural Networks, such as deep learning models, e.g., feedforward neural networks or convolutional neural networks, can be utilized to predict link capacity by learning complex patterns and relationships in large datasets. They are particularly advantageous when dealing with high-dimensional data and non-linear dependencies.

In some embodiments, RNNs, including Long Short-Term Memory (LSTM) networks, are well-suited for time-series prediction tasks, making them ideal for estimating link capacity based on sequential data inputs and temporal patterns.

In some embodiments, Bayesian Networks are probabilistic models that can be used to predict link capacity by incorporating uncertainty and prior knowledge into the estimation process, providing a robust framework for decision-making under uncertainty.

In some embodiments, Ensemble Methods can include techniques such as boosting and bagging can be applied to combine multiple models, enhancing prediction accuracy and reducing overfitting by leveraging the strengths of different machine learning approaches.

These machine learning models can be trained using historical data, simulated scenarios, and real-time measurements to provide accurate and dynamic capacity estimates, enabling effective management and optimization of wireless communication links. on both historical and simulated data, the system can identify complex patterns and correlations that might not be apparent through traditional modeling methods. These models can adapt to new data inputs, continuously refining their predictions as more information becomes available.

Additionally, the Network Model 104 can be designed to accommodate real-time updates, allowing it to adjust its predictions based on current link state information. This dynamic capability ensures that the model remains relevant and accurate, even as conditions change rapidly.

In some embodiments, the Queue Management 120 can organize and prioritize data packets to be transmitted over the Wireless Communication Link 132. By leveraging the Predicted Capacity Estimate 106, the Queue Management 120 can dynamically adjust the queuing strategy to ensure efficient use of the link, minimizing latency and maximizing throughput utilizing one or more queuing models and/or dynamic queuing functions. The Queue Management 120 is a queuing function that isolates applications and users providing fairness across both while maintaining a target latency. To successfully accomplish this, the Queue Management 120 accepts the predicted capacity estimate 106 on a frequent basis, e.g., second, 5 seconds, 10 seconds, 15 seconds, 30 seconds, every minute, 5 minutes, 10 minutes, 15 minutes, 30 minutes, hour, or more. To maintain a low latency connection, the Queue Management 120 may utilize the predicted capacity estimate 106 to prevent the queuing within the network from exceeding a threshold level that would impede latency below a quality-of-service.

In some embodiments, the queuing model(s) can be employed to manage and optimize the transmission of data packets over a wireless communication link. These models are designed to efficiently handle the flow of data, minimizing latency and maximizing throughput by organizing and prioritizing packets based on predicted link capacity, such as First-In-First-Out (FIFO) Queuing, Priority Queuing, Weighted Fair Queuing (WFQ), Round Robin Queuing, Deficit Round Robin (DRR), Random Early Detection (RED), Adaptive Queuing, among others or any combination thereof.

In some embodiments, FIFO Queuing can process packets in the order they arrive, ensuring a straightforward and predictable queuing strategy. FIFO is simple to implement and can be effective in scenarios where packet arrival times are consistent and predictable.

In some embodiments, Priority Queuing can include assigning different priority levels to packets based on their importance or type. High-priority packets, such as those related to real-time applications like voice or video, are processed before lower-priority packets, ensuring timely delivery of critical data.

In some embodiments, WFQ can include allocating bandwidth to different packet flows based on predefined weights. This ensures that each flow receives a fair share of the link capacity, preventing any single flow from monopolizing the bandwidth and causing delays for others.

In some embodiments, Round Robin Queuing can include processing packets in a cyclic order, with each flow receiving an equal opportunity to transmit data. Round Robin is useful in scenarios where fairness among multiple flows is a priority, ensuring balanced access to the communication link.

In some embodiments, DRR is an enhancement of Round Robin queuing, where each flow is assigned a deficit counter that tracks its share of the bandwidth. This embodiment allows for more flexible bandwidth allocation, accommodating varying packet sizes and flow requirements.

In some embodiments, RED can include proactively managing congestion by randomly dropping packets before the queue becomes full. This approach helps prevent buffer overflow and reduces packet loss, maintaining optimal performance of the communication link.

In some embodiments, Adaptive Queuing can dynamically adjust based on real-time link conditions and predicted capacity estimates. Adaptive queuing can respond to changes in network traffic and environmental factors, ensuring efficient use of the link under varying conditions.

These queuing models can be tailored to the specific needs of the wireless communication environment, providing flexibility and robustness in managing data transmission. By leveraging predicted capacity estimates, these models can optimize the queuing strategy to maintain high-quality communication and enhance user experience.

The Wireless Communication Equipment 130 interfaces with the Wireless Communication Link 132, which is the physical medium for data transmission. The equipment is tasked with executing the transmission of data packets as directed by the Queue Management 120, based on the capacity predictions provided by the Dynamic Link Estimation 110. While, for illustrative purposes, the techniques herein are described in relation to network uplink, the techniques described are, in general, applicable to both the uplink as well as downlink. In the case of the network uplink, the Dynamic Link Estimation 110 function is instantiated in the remote station.

Overall, the system depicted in FIG. 1 represents an innovative approach to managing wireless communication links 132, utilizing real-time data and predictive modeling to enhance the quality and efficiency of data transmission.

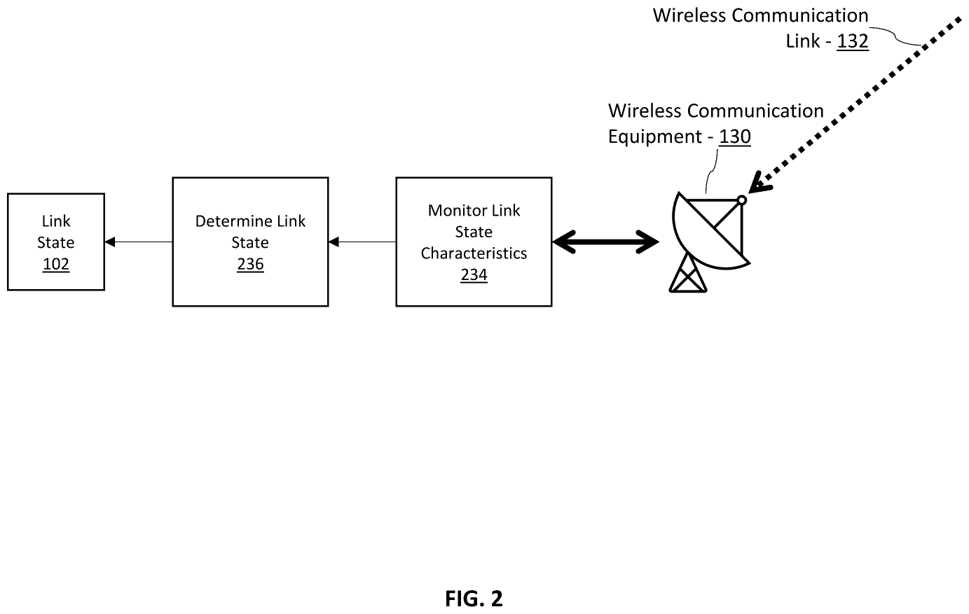

Referring now to FIG. 2, a system is shown for generating the Link State 102 through the monitoring and determination of link state characteristics. The system is designed to optimize the transmission and reception of communications by utilizing data related to the operation of the Wireless Communication Equipment 130 and the Wireless Communication Link 132.

The Wireless Communication Equipment 130 interfaces with the Wireless Communication Link 132, serving as the physical medium for data transmission. This equipment is responsible for executing the transmission of data packets, and its operation can be monitored to determine link state characteristics. The monitoring of link state characteristics is performed by the Monitor Link State Characteristics 234, which gathers data related to both passive and active link characteristics. Passive characteristics may include signal-to-interference-and-noise ratio (SINR) and elevation angle, which are influenced by external environmental factors and can be gathered without active probing. Active characteristics, on the other hand, involve intentional probing techniques, such as over-the-air pings, to assess latency and other device-related performance measurements.

The Monitor Link State Characteristics 234 supplies the required data inputs to the Determine Link State 236, which processes this information to establish the current Link State 102. The determination of the link state is an important step in understanding the real-time performance and potential limitations of the Wireless Communication Link 132. By accurately assessing the link state, the system can make informed decisions about data transmission and enhance the use of the communication link.

The Link State 102 represents the present conditions and characteristics of the Wireless Communication Link 132. This state serves as an input for various predictive models and functions within the system, enabling dynamic link capacity estimation and effective queue management. The capability to update the Link State 102 with new data inputs on an ongoing basis ensures that the system can adapt to changing network conditions and maintain optimal performance.

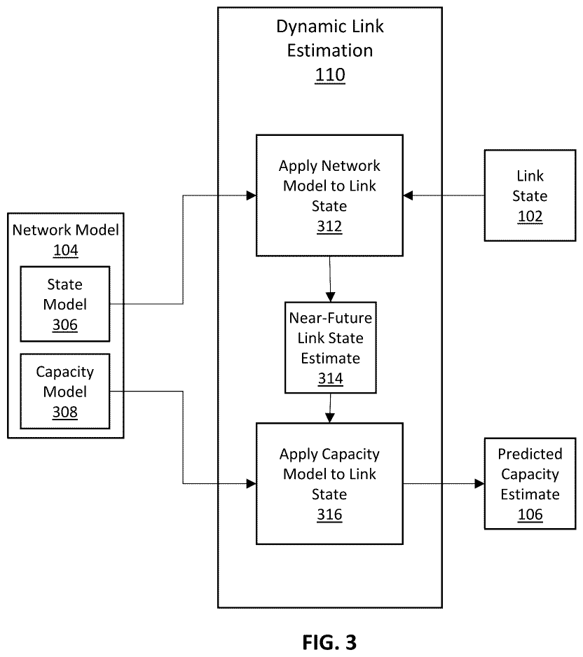

Referring now to FIG. 3, FIG. 3 shows a system for generating a predicted capacity estimate 106 through the dynamic link estimation 110 process. The system is designed to optimize the transmission and reception of communications by utilizing data related to the operation of the link state 102 and the network model 104.

The link state 102 represents the current conditions and characteristics of the wireless communication link. This state serves as an input for the dynamic link estimation 110, enabling the system to predict future link conditions and manage data transmission effectively. The link state 102 is important for understanding the real-time performance and potential limitations of the communication link.

The network model 104 serves as a component that offers a representation of the behavior of the wireless communication link under varying conditions. This model encompasses the state model 306 and the capacity model 308, which collaborate to enhance the precision of predictions. The state model 306 concentrates on forecasting the near-future link state estimate 314, which indicates expected alterations in the link's conditions. This model integrates various state parameters, such as signal-to-interference-and-noise ratio (SINR) and user terminal elevation, to deliver a comprehensive understanding of the link's present performance.

The capacity model 308 is dedicated to estimating the data capacity of the wireless communication link. Inputs from the state model 306 are utilized to forecast the link's ability to carry data under various conditions. The capacity model 308 plays a role in optimizing the use of the wireless communication link, ensuring that data transmission is efficient and latency is minimized.

The dynamic link estimation 110 process begins with applying the network model to the link state 312. This step involves using the network model 104 to interpret the current link state 102 and predict the near-future link state estimate 314. The near-future link state estimate 314 is then used to apply the capacity model 308 to the near-future link state estimate 314 in an apply capacity model to link state 316, producing the predicted capacity estimate 106.

Referring now to FIG. 4, the Network Simulation(s) 402 may be used to predict and manage dynamic link capacity in satellite communication networks. These simulations replicate various environmental conditions, user behaviors, and network configurations to forecast the performance of the Wireless Communication Link 132 under different circumstances. By simulating both idealized and actual network scenarios, the Network Simulation(s) 402 provide a comprehensive understanding of potential link behaviors, which may not be observable in real-world data. This approach allows the system to explore a broader range of possible outcomes, enhancing the accuracy of the predictive models. The simulations are important for generating detailed satellite constellation states and incorporating historical usage data, which are then used by the Predictive Model Generation Function 440 to produce models that accurately assess current link capacity.

The State(s) 404 component is closely linked to the Network Simulation(s) 402, as it represents the various conditions and characteristics of the network that are simulated. These states include parameters such as signal-to-interference-and-noise ratio (SINR), user terminal elevation, and other passive characteristics that influence the link's performance. The State(s) 404 provide inputs for the Predictive Model Generation Function 440, offering the data required to create models that reflect the real-time conditions of the Wireless Communication Link 132. By incorporating both passive and active measurements, the State(s) 404 contribute to the robustness and adaptability of the predictive models to changing network conditions, facilitating accurate link capacity estimation.

The Predictive Model Generation Function 440 serves as a central component, responsible for creating models that forecast the behavior of the Wireless Communication Link 132. This function utilizes inputs from the Network Simulation(s) 402 and Historic Usage Data 406 to generate predictive models that are employed by the Dynamic Link Capacity Estimation Function to evaluate current link capacity. The Predictive Model Generation Function 440 employs various techniques, including machine learning and correlation functions, to produce models that can adapt to new data inputs and continuously refine their predictions. By leveraging detailed knowledge of user terminal capabilities and historical data, this function ensures that the models remain relevant and accurate, even as network conditions change rapidly.

The Historic Usage Data 406 can provide extensive information regarding past network performance, which plays a significant role in the Predictive Model Generation Function 440. This data encompasses previous link capacity measurements, environmental conditions, and user terminal performance metrics, providing a thorough foundation for forecasting link behavior. By examining trends and patterns in the Historic Usage Data 406, the Predictive Model Generation Function 440 can enhance the precision of predictions, ensuring that the models represent the real-world dynamics of the Wireless Communication Link 132. This historical data is especially useful for identifying complex correlations and patterns that might not be evident through traditional modeling methods.

In some embodiments, the network model 104 (e.g., the state model 306 and/or the capacity model 308) ingests a feature vector that encodes features representative of network simulation(s) 402 data, such as actual and/or simulated state(s) 404. In some embodiments, the network model 104 (e.g., the state model 306 and/or the capacity model 308) processes the feature vector with parameters to produces a prediction of predicted capacity. In some embodiments, the parameters of the network model 104 (e.g., the state model 306 and/or the capacity model 308) may be implemented in a suitable machine learning model including a prediction machine learning model, such as, e.g., Linear Regression, Logistic Regression, Ridge Regression, Lasso Regression, Polynomial Regression, Bayesian Linear Regression (e.g., Naive Bayes regression), a convolutional neural network (CNN), a recurrent neural network (RNN), decision trees, random forest, support vector machine (SVM), K-Nearest Neighbors, or any other suitable algorithm for predicting output values based on input values. In some embodiments, for computational efficiency while preserving accuracy of predictions, the network model 104 (e.g., the state model 306 and/or the capacity model 308) may advantageously include a random forest model.

In some embodiments, the network model 104 (e.g., the state model 306 and/or the capacity model 308) processes the features encoded in the feature vector by applying the parameters of the prediction machine learning model to produce a model output vector. In some embodiments, the model output vector may be decoded to generate one or more numerical output values indicative of predicted capacity. In some embodiments, the model output vector may include or may be decoded to reveal the output value(s) based on a modelled correlation between the feature vector and a target output. In some embodiments, the numerical output may represent one or more predicted capacity estimates at an associated point in time.

In some embodiments, the above training methodology may be utilized to create a trained state model 306 trained to output near-future state predictions based on the network simulation(s) 402, and/or to create a trained capacity model 308 trained to output the predicted link state estimate based on the historic usage data 406.

For example, the parameters of the network model 104 (e.g., the state model 306 and/or the capacity model 308) may be trained based on known link capacity results. For example, the network simulation(s) 402, including actual and/or simulated state(s) 404 may be paired with a target value or known value to form a training pair, such as a historical network simulation(s) 402, including actual and/or simulated state(s) 404, and an observed result (e.g., the historic usage data 406 or derived therefrom) to train the capacity model 308 to model the predicted link capacity estimate(s). Similarly, the parameters of the network model 104 (e.g., the state model 306 and/or the capacity model 308) may be trained based on known next-step link states (e.g., a link state at a next period of time relative to an input state(s) 404). For example, the network simulation(s) 402, including actual and/or simulated state(s) 404 may be paired with a target value or known value to form a training pair, such as a time series of the historical network simulation(s) 402, including actual and/or simulated state(s) 404, where a first state(s) 404 is used as input and a second state(s) 404 that occurs after the first state(s) 404 is used as an observed result to train the state model 306 to model the state behavior.

In some embodiments, the network simulation(s) 402, including actual and/or simulated state(s) 404 may be provided to the network model 104 (e.g., the state model 306 and/or the capacity model 308), e.g., encoded in a feature vector, to produce a predicted output value. In some embodiments, an optimization function associated with the network model 104 (e.g., the state model 306 and/or the capacity model 308) may then compare the predicted output value with the known output of a training pair including the historical network simulation(s) 402, including actual and/or simulated state(s) 404 to determine an error of the predicted output value. In some embodiments, the optimization function may employ a loss function, such as, e.g., Hinge Loss, Multi-class SVM Loss, Cross Entropy Loss, Negative Log Likelihood, or other suitable classification loss function to determine the error of the predicted output value based on the known output.

In some embodiments, the known output may be obtained after the network model 104 (e.g., the state model 306 and/or the capacity model 308) produces the prediction, such as in online learning scenarios. In such a scenario, the network model 104 (e.g., the state model 306 and/or the capacity model 308) may receive the network simulation(s) 402, including actual and/or simulated state(s) 404 and generate the model output vector to produce an output value representing the predicted link capacity estimate. Subsequently, a user may provide feedback by, e.g., modifying, adjusting, removing, and/or verifying the output value via a suitable feedback mechanism, such as a user interface device (e.g., keyboard, mouse, touch screen, user interface, or other interface mechanism of a user device or any suitable combination thereof). The feedback may be paired with the network simulation(s) 402, including actual and/or simulated state(s) 404 to form the training pair and the optimization function may determine an error of the predicted output value using the feedback.

In some embodiments, based on the error, the optimization function may update the parameters of the network model 104 (e.g., the state model 306 and/or the capacity model 308) using a suitable training algorithm such as, e.g., backpropagation for a prediction machine learning model. In some embodiments, backpropagation may include any suitable minimization algorithm such as a gradient method of the loss function with respect to the weights of the prediction machine learning model. Examples of suitable gradient methods include, e.g., stochastic gradient descent, batch gradient descent, mini-batch gradient descent, or other suitable gradient descent technique. As a result, the optimization function may update the parameters of the network model 104 (e.g., the state model 306 and/or the capacity model 308) based on the error of predicted labels in order to train the network model 104 (e.g., the state model 306 and/or the capacity model 308) to model the correlation between network simulation(s) 402, including actual and/or simulated state(s) 404 and predicted capacity in order to produce more accurate output values based on network simulation(s) 402, including actual and/or simulated state(s) 404.

The Network Model 104 is the output of the Predictive Model Generation Function 440, encapsulating the behavior of the Wireless Communication Link 132 under various conditions. This model can include two sub-components: the State Model 306 and the Capacity Model 308. The Network Model 104 serves as an important input for the Dynamic Link Capacity Estimation Function, providing the necessary framework to predict link capacity based on current state information. By integrating historical data, simulated scenarios, and real-time measurements, the Network Model 104 offers a dynamic and accurate representation of the link's potential performance, enabling effective management and optimization of wireless communication links.

The State Model 306 is a sub-component of the Network Model 104, focusing on the real-time conditions and characteristics of the Wireless Communication Link 132. This model incorporates various state parameters, such as SINR and user terminal elevation, to provide a detailed understanding of the link's current performance. The State Model 306 plays a significant role in predicting how these conditions will affect link capacity, allowing the Dynamic Link Capacity Estimation Function to make informed decisions about data transmission and queue management. By continuously updating the State Model 306 with new data inputs, the system can adapt to changing network conditions and maintain optimal performance.

The Capacity Model 308 is another sub-component of the Network Model 104, dedicated to estimating the data capacity of the Wireless Communication Link 132. This model uses inputs from the State Model 306 and Predictive Model Generation Function 440 to forecast the link's ability to carry data under various conditions. The Capacity Model 308 plays a significant role in optimizing the use of the wireless communication link, ensuring that data transmission is efficient and latency is minimized. By leveraging predicted capacity estimates, the Capacity Model 308 enables the system to dynamically adjust the system's queuing strategy, enhancing user experience and maintaining high-quality communication.

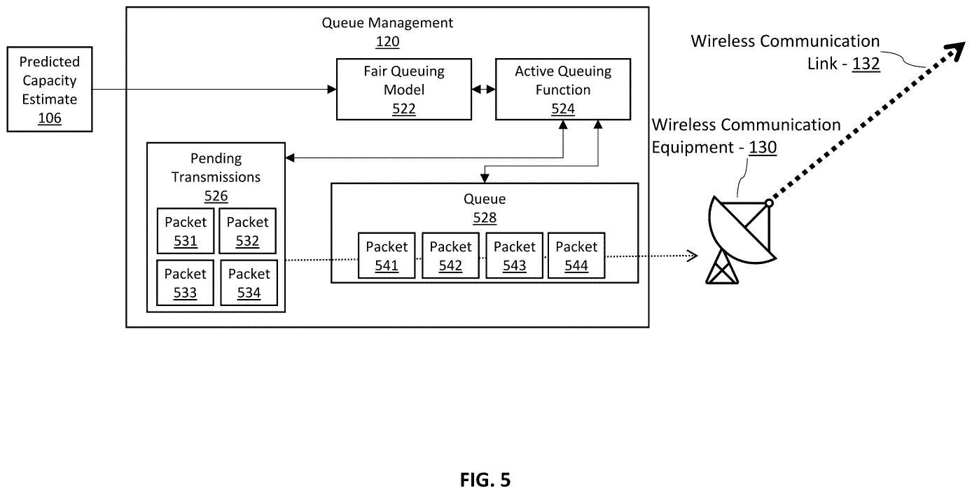

Referring now to FIG. 5, the Predicted Capacity Estimate 106 can be utilized for the dynamic link capacity estimation system, serving as the output of the predictive models that assess the current link capacity. This estimate is derived from the Network Model 104, which integrates historical data, simulated scenarios, and real-time measurements to provide a dynamic and accurate representation of the link's potential performance. The Predicted Capacity Estimate 106 is used to govern the queuing discipline of the Queue Management 120, ensuring efficient use of the wireless communication link by dynamically adjusting the queuing strategy to minimize latency and maximize throughput. This component is crucial for maintaining high-quality communication and enhancing user experience by providing a real-time assessment of the link's available capacity.

The Queue Management 120 is responsible for organizing and prioritizing data packets to be transmitted over the Wireless Communication Link 132. The system leverages the Predicted Capacity Estimate 106 to dynamically adjust the queuing strategy, ensuring efficient use of the link and minimizing latency. The Queue Management 120 includes various queuing models and functions, such as the Fair Queuing Model 522 and the Active Queuing Function 524, which work together to manage the flow of data packets based on predicted link capacity. This component plays a significant role in maintaining a low latency connection and providing a configuration-less Quality of Experience to end-users by preventing the queuing within the network from exceeding a threshold level that would impede latency below a quality-of-service.

The Fair Queuing Model 522 is a sub-component of the Queue Management 120, designed to allocate bandwidth to different packet flows based on predefined weights. This approach ensures that each flow receives an equitable portion of the link capacity, preventing any single flow from monopolizing the bandwidth and causing delays for others. The Fair Queuing Model 522 is particularly useful in scenarios where fairness among multiple flows is a priority, ensuring balanced access to the communication link.

For example, the Fair Queuing Model 522 can include weight fair queueing. In some embodiments, WFQ can include allocating bandwidth to different packet flows based on predefined weights. This ensures that each flow receives a fair share of the link capacity, preventing any single flow from monopolizing the bandwidth and causing delays for others. By integrating the Predicted Capacity Estimate 106, the model can dynamically adjust the strategy to optimize the queuing process and maintain high-quality communication.

The Active Queuing Function 524 is another sub-component of the Queue Management 120, tasked with isolating applications and users to provide fairness across both while maintaining a target latency. This function accepts the current estimated link capacity on a frequent basis, using the capacity to prevent the queuing within the network from becoming unreasonably high. The Active Queuing Function 524 plays a significant role in maintaining a low latency connection and ensuring efficient use of the link under varying conditions. By leveraging predicted capacity estimates, this function can dynamically adjust its strategy to optimize the queuing process and enhance user experience.

The Pending Transmissions 526 represent the data packets that are queued within the Queue Management 120, awaiting transmission over the Wireless Communication Link 132. These packets are organized and prioritized based on the queuing strategy implemented by the Fair Queuing Model 522 and the Active Queuing Function 524. The Pending Transmissions 526 are released from the queue based on the predicted link capacity, ensuring efficient use of the link and minimizing latency. This component plays a significant role in maintaining high-quality communication and providing a configuration-less Quality of Experience to end-users.

The Queue 528 is a sub-component of the Queue Management 120, responsible for storing data packets that are awaiting transmission over the Wireless Communication Link 132. The Queue 528 is managed by the Fair Queuing Model 522 and the Active Queuing Function 524, which dynamically adjust the queuing strategy based on the Predicted Capacity Estimate 106. This component plays a significant role in maintaining a low latency connection and ensuring efficient use of the link under varying conditions. By leveraging predicted capacity estimates, the Queue 528 can optimize the queuing process and enhance user experience.

The Packets 531, 532, 533, 534, 541, 542, 543, and 544 represent individual data packets that are queued within the Queue Management 120, awaiting transmission over the Wireless Communication Link 132. These packets are organized and prioritized based on the queuing strategy implemented by the Fair Queuing Model 522 and the Active Queuing Function 524. The Packets are released from the queue based on the predicted link capacity, ensuring efficient use of the link and minimizing latency. These components play a significant role in maintaining high-quality communication and providing a configuration-less Quality of Experience to end-users.

The Wireless Communication Link 132 serves as the physical medium for data transmission, connecting with the Wireless Communication Equipment 130 to carry out the transmission of data packets as instructed by the Queue Management 120. The Wireless Communication Link 132 acts as the channel through which data packets are transmitted, and the capacity of this channel is dynamically estimated by the Predicted Capacity Estimate 106. This component plays a significant role in maintaining high-quality communication and ensuring efficient use of the link under varying conditions. By utilizing predicted capacity estimates, the Wireless Communication Link 132 can improve the transmission process and enhance user experience.

The Wireless Communication Equipment 130 interfaces with the Wireless Communication Link 132, executing the transmission of data packets as directed by the Queue Management 120. This equipment is tasked with ensuring efficient use of the link and minimizing latency by dynamically adjusting the transmission process based on the Predicted Capacity Estimate 106. The Wireless Communication Equipment 130 plays a significant role in maintaining high-quality communication and providing a configuration-less Quality of Experience to end-users. By leveraging predicted capacity estimates, this equipment can optimize the transmission process and enhance user experience.

In some embodiments, the Queue Management 120 can organize and prioritize data packets to be transmitted over the Wireless Communication Link 132. By leveraging the Predicted Capacity Estimate 106, the Queue Management 120 can dynamically adjust the queuing strategy to ensure efficient use of the link, minimizing latency and maximizing throughput utilizing one or more queuing models and/or dynamic queuing functions.

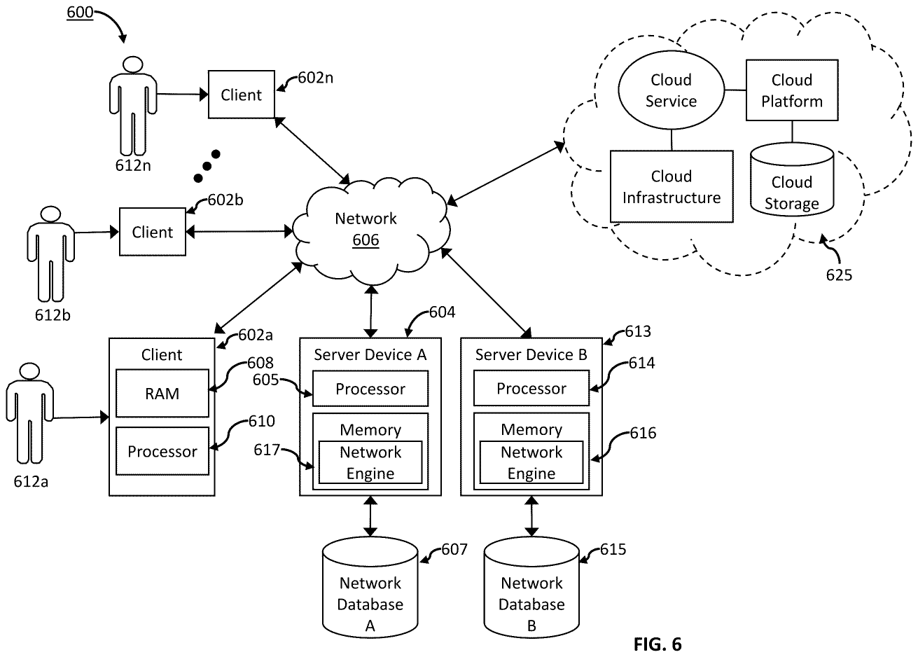

FIG. 6 depicts a block diagram of another exemplary computer-based system and platform 600 for dynamic link estimation of wireless communication links in accordance with one or more embodiments of the present disclosure. However, not all of these components may be required to practice one or more embodiments, and variations in the arrangement and type of the components may be made without departing from the spirit or scope of various embodiments of the present disclosure.

In some embodiments, the client devices 602a, 602b through 602n shown each at least includes a computer-readable medium, such as a random-access memory (RAM) 608 coupled to a processor 610 or FLASH memory. In some embodiments, the processor 610 may execute computer-executable program instructions stored in memory 608. In some embodiments, the processor 610 may include a microprocessor, an ASIC, and/or a state machine. In some embodiments, the processor 610 may include, or may be in communication with, media, for example computer-readable media, which stores instructions that, when executed by the processor 610, may cause the processor 610 to perform one or more steps described herein. In some embodiments, examples of computer-readable media may include, but are not limited to, an electronic, optical, magnetic, or other storage or transmission device capable of providing a processor, such as the processor 610 of client device 602a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, client devices 602a through 602n may also comprise a number of external or internal devices such as a mouse, a CD-ROM, DVD, a physical or virtual keyboard, a display, or other input or output devices. In some embodiments, examples of client devices 602a through 602n (e.g., clients) may be any type of processor-based platforms that are connected to a network 606 such as, without limitation, personal computers, digital assistants, personal digital assistants, smart phones, pagers, digital tablets, laptop computers, Internet appliances, and other processor-based devices. In some embodiments, client devices 602a through 602n may be specifically programmed with one or more application programs in accordance with one or more principles/methodologies detailed herein. In some embodiments, client devices 602a through 602n may operate on any operating system capable of supporting a browser or browser-enabled application, such as Microsoft™, Windows™, and/or Linux. In some embodiments, client devices 602a through 602n shown may include, for example, personal computers executing a browser application program such as Microsoft Corporation's Internet Explorer™, Apple Computer, Inc.'s Safari™, Mozilla Firefox, and/or Opera.

In some embodiments, through the member computing client devices 602a through 602n, users, 612a through 602n, may communicate, e.g., via wireless communication links, such as wireless communication link 132 using wireless communication equipment 130 as detailed above, over the exemplary network 606 with each other and/or with other systems and/or devices coupled to the network 606. As shown in FIG. 6, exemplary server devices 604 and 613 may include processor 605 and processor 614, respectively, as well as memory 617 and memory 616, respectively. In some embodiments, the server devices 604 and 613 may be also coupled to the network 606. In some embodiments, one or more client devices 602a through 602n may be mobile clients.

In some embodiments, at least one database of exemplary databases 607 and 615 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

In some embodiments, the exemplary inventive computer-based systems/platforms, the exemplary inventive computer-based devices, and/or the exemplary inventive computer-based components of the present disclosure may be specifically configured to operate in a cloud computing/architecture 625 such as, but not limiting to: infrastructure a service (IaaS), platform as a service (PaaS), and/or software as a service (SaaS) using a web browser, mobile app, thin client, terminal emulator or other endpoint.

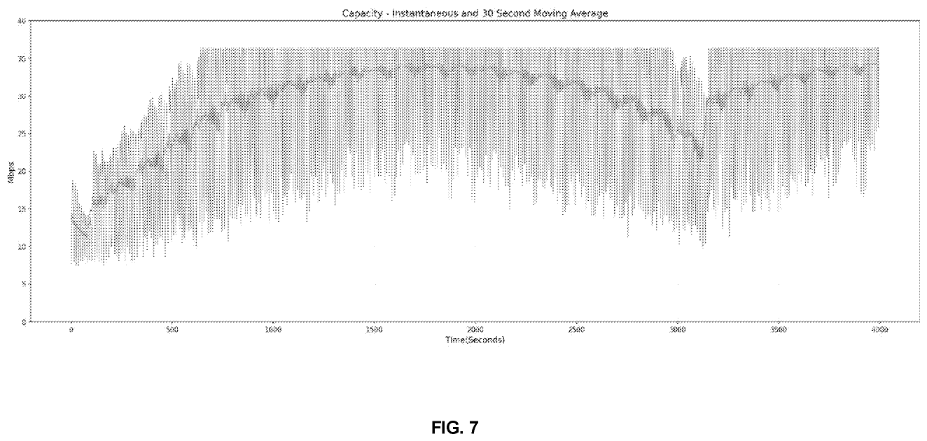

FIG. 7 shows both instantaneous and averaged bandwidth for a LEO satellite link. This variability complicates matters for external network devices directly connected to the remote earth station, as they require accurate estimates of available capacity to avoid excessive latency and jitter from queuing. Our invention presents a set of methods for accurately estimating current link capacity from a remote earth station, independent of network congestion, ensuring low latency and minimal jitter in communication as well as using that estimate to enhance user Quality of Experience. Additionally, based on historical data as well as real-time network congestion, the methods can be used to accurately estimate return link capacity via a monitoring gateway.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999) , at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.

Clause 1. A method comprising: obtaining, by at least one processor, at least one wireless communication link characteristic associated with a wireless communication link between at least one communication device and at least one remote communication device; wherein the at least one wireless communication link characteristic comprises at least one performance affecting measurement associated with a performance of the wireless communication link; determining, by the at least one processor, in real-time, based at least in part on the at least one wireless communication link characteristic, at least one link state associated with the wireless communication link; inputting, by the at least one processor, in real-time, the at least one link state into at least one predictive capacity estimation model to output a dynamic link capacity estimate representative of a link state-dependent data capacity of the wireless communication link; wherein the link state-dependent data capacity is indicative of a quantity of data the wireless communication link is estimated to be capable of carrying based on the at least one link state; wherein the at least one predictive model models a link capacity response resulting from the at least one wireless communication link characteristic; wherein the at least one predictive model is based at least in part on model link capacity data; and controlling, by the at least one processor, a queue of wireless communication equipment for transmission of queued wireless communications based at least in part on the link capacity estimate to optimize use of the wireless communication link.

Clause 2. The method of clause 1, wherein the wireless communication link comprises at least one of an uplink or a downlink, or both.

Clause 3. The method of clause 1, wherein the at least one remote communication device comprises at least one non-terrestrial communication device.

Clause 4. The method of clause 1, further comprising: transmitting, by the at least one processor, at least one probe signal over the wireless communication link; measuring, by the at least one processor, at least one probed wireless communication link characteristic of the wireless communication between link; wherein the at least one probed wireless communication link characteristic comprises at least one device-related performance measurement associated with a behavior of the at least one probe signal over the wireless communication link; and determining, by the at least one processor, in real-time, based at least in part on the at least one wireless communication link characteristic and the at least one probed wireless communication link characteristic, the at least one link state associated with the wireless communication link.

Clause 5. The method of clause 4, wherein the at least one probed wireless communication link characteristic comprises latency over the wireless communication link.

Clause 6. The method of clause 1, wherein the at least one predictive model comprises at least one of: at least one correlation function, or at least one machine learning model.

Clause 7. The method of clause 1, wherein the model link data comprises at least one of: historical link capacity data representative of historical link capacity measurements, or simulated link capacity data representative of simulated link capacity measurements.

Clause 8. The method of clause 1, wherein the link capacity estimate is representative of a prediction of a return link capacity over the wireless communication link, the return link capacity being associated with quantity of data the wireless communication link is estimated to be capable of carrying in a return wireless communication in response to a sent wireless communication between the at least one communication device and at least one remote communication device.

Clause 9. The method of clause 1, wherein the at least one wireless communication link characteristic comprises at least one of: a slant range associated with at least one of the at least one communication device and at least one remote communication device, a communication device elevation associated with at least one of the at least one communication device and at least one remote communication device, or a communication device performance associated with at least one of the at least one communication device and at least one remote communication device.

Clause 10. The method of clause 9, wherein the communication device performance comprises signal-to-interference-and-noise ratio (SINR).

Clause 11. A system comprising: at least one processor associated with at least one communication device; and at least one non-transitory computer-readable medium having software instructions stored thereon; wherein the at least one processor, upon execution of the software instructions, is configured to: obtain at least one wireless communication link characteristic associated with a wireless communication link between the at least one communication device and at least one remote communication device; wherein the at least one wireless communication link characteristic comprises at least one performance affecting measurement associated with a performance of the wireless communication link; determine, in real-time, based at least in part on the at least one wireless communication link characteristic, at least one link state associated with the wireless communication link; input, in real-time, the at least one link state into at least one predictive capacity estimation model to output a dynamic link capacity estimate representative of a link state-dependent data capacity of the wireless communication link; wherein the link state-dependent data capacity is indicative of a quantity of data the wireless communication link is estimated to be capable of carrying based on the at least one link state; wherein the at least one predictive model models a link capacity response resulting from the at least one wireless communication link characteristic; wherein the at least one predictive model is based at least in part on model link capacity data; and control a queue of wireless communication equipment for transmission of queued wireless communications based at least in part on the link capacity estimate to optimize use of the wireless communication link.

Clause 12. The system of clause 11, wherein the wireless communication link comprises at least one of an uplink or a downlink, or both.

Clause 13. The system of clause 11, wherein the at least one remote communication device comprises at least one non-terrestrial communication device.

Clause 14. The system of clause 11, wherein the at least one processor, upon execution of the software instructions, is further configured to: transmit at least one probe signal over the wireless communication link; measure at least one probed wireless communication link characteristic of the wireless communication between link; wherein the at least one probed wireless communication link characteristic comprises at least one device-related performance measurement associated with a behavior of the at least one probe signal over the wireless communication link; and determine, in real-time, based at least in part on the at least one wireless communication link characteristic and the at least one probed wireless communication link characteristic, the at least one link state associated with the wireless communication link.

Clause 15. The system of clause 14, wherein the at least one probed wireless communication link characteristic comprises latency over the wireless communication link.

Clause 16. The system of clause 11, wherein the at least one predictive model comprises at least one of: at least one correlation function, or at least one machine learning model.

Clause 17. The system of clause 11, wherein the model link data comprises at least one of: historical link capacity data representative of historical link capacity measurements, or simulated link capacity data representative of simulated link capacity measurements.

Clause 18. The system of clause 11, wherein the link capacity estimate is representative of a prediction of a return link capacity over the wireless communication link, the return link capacity being associated with quantity of data the wireless communication link is estimated to be capable of carrying in a return wireless communication in response to a sent wireless communication between the at least one communication device and at least one remote communication device.

Clause 19. The system of clause 11, wherein the at least one wireless communication link characteristic comprises at least one of: a slant range associated with at least one of the at least one communication device and at least one remote communication device, a communication device elevation associated with at least one of the at least one communication device and at least one remote communication device, or a communication device performance associated with at least one of the at least one communication device and at least one remote communication device.

Clause 20. The system of clause 19, wherein the communication device performance comprises signal-to-interference-and-noise ratio (SINR).

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method comprising:
obtaining, by at least one processor, at least one wireless communication link characteristic associated with a wireless communication link between at least one communication device and at least one remote communication device;
wherein the at least one wireless communication link characteristic comprises at least one performance affecting measurement associated with a performance of the wireless communication link;
determining, by the at least one processor, in real-time, based at least in part on the at least one wireless communication link characteristic, at least one link state associated with the wireless communication link;
inputting, by the at least one processor, in real-time, the at least one link state into at least one predictive capacity estimation model to output a dynamic link capacity estimate representative of a link state-dependent data capacity of the wireless communication link;
wherein the link state-dependent data capacity is indicative of a quantity of data the wireless communication link is estimated to be capable of carrying based on the at least one link state;
wherein the at least one predictive model models a link capacity response resulting from the at least one wireless communication link characteristic;
wherein the at least one predictive model is based at least in part on model link capacity data; and
controlling, by the at least one processor, a queue of wireless communication equipment for transmission of queued wireless communications based at least in part on the link capacity estimate to optimize use of the wireless communication link.

2. The method of claim 1, wherein the wireless communication link comprises at least one of an uplink or a downlink, or both.

3. The method of claim 1, wherein the at least one remote communication device comprises at least one non-terrestrial communication device.

4. The method of claim 1, further comprising:
transmitting, by the at least one processor, at least one probe signal over the wireless communication link;
measuring, by the at least one processor, at least one probed wireless communication link characteristic of the wireless communication between link;
wherein the at least one probed wireless communication link characteristic comprises at least one device-related performance measurement associated with a behavior of the at least one probe signal over the wireless communication link; and
determining, by the at least one processor, in real-time, based at least in part on the at least one wireless communication link characteristic and the at least one probed wireless communication link characteristic, the at least one link state associated with the wireless communication link.

5. The method of claim 4, wherein the at least one probed wireless communication link characteristic comprises latency over the wireless communication link.

6. The method of claim 1, wherein the at least one predictive model comprises at least one of:
at least one correlation function, or
at least one machine learning model.

7. The method of claim 1, wherein the model link data comprises at least one of:
historical link capacity data representative of historical link capacity measurements, or
simulated link capacity data representative of simulated link capacity measurements.

8. The method of claim 1, wherein the link capacity estimate is representative of a prediction of a return link capacity over the wireless communication link, the return link capacity being associated with quantity of data the wireless communication link is estimated to be capable of carrying in a return wireless communication in response to a sent wireless communication between the at least one communication device and at least one remote communication device.

9. The method of claim 1, wherein the at least one wireless communication link characteristic comprises at least one of:
a slant range associated with at least one of the at least one communication device and at least one remote communication device,
a communication device elevation associated with at least one of the at least one communication device and at least one remote communication device, or
a communication device performance associated with at least one of the at least one communication device and at least one remote communication device.

10. The method of claim 9, wherein the communication device performance comprises signal-to-interference-and-noise ratio (SINR).

11. A system comprising:
at least one processor associated with at least one communication device; and
at least one non-transitory computer-readable medium having software instructions stored thereon;
wherein the at least one processor, upon execution of the software instructions, is configured to:
obtain at least one wireless communication link characteristic associated with a wireless communication link between the at least one communication device and at least one remote communication device;
wherein the at least one wireless communication link characteristic comprises at least one performance affecting measurement associated with a performance of the wireless communication link;
determine, in real-time, based at least in part on the at least one wireless communication link characteristic, at least one link state associated with the wireless communication link;
input, in real-time, the at least one link state into at least one predictive capacity estimation model to output a dynamic link capacity estimate representative of a link state-dependent data capacity of the wireless communication link;
wherein the link state-dependent data capacity is indicative of a quantity of data the wireless communication link is estimated to be capable of carrying based on the at least one link state;
wherein the at least one predictive model models a link capacity response resulting from the at least one wireless communication link characteristic;
wherein the at least one predictive model is based at least in part on model link capacity data; and
control a queue of wireless communication equipment for transmission of queued wireless communications based at least in part on the link capacity estimate to optimize use of the wireless communication link.

12. The system of claim 11, wherein the wireless communication link comprises at least one of an uplink or a downlink, or both.

13. The system of claim 11, wherein the at least one remote communication device comprises at least one non-terrestrial communication device.

14. The system of claim 11, wherein the at least one processor, upon execution of the software instructions, is further configured to:
transmit at least one probe signal over the wireless communication link;
measure at least one probed wireless communication link characteristic of the wireless communication between link;
wherein the at least one probed wireless communication link characteristic comprises at least one device-related performance measurement associated with a behavior of the at least one probe signal over the wireless communication link; and
determine, in real-time, based at least in part on the at least one wireless communication link characteristic and the at least one probed wireless communication link characteristic, the at least one link state associated with the wireless communication link.

15. The system of claim 14, wherein the at least one probed wireless communication link characteristic comprises latency over the wireless communication link.

16. The system of claim 11, wherein the at least one predictive model comprises at least one of:
at least one correlation function, or
at least one machine learning model.

17. The system of claim 11, wherein the model link data comprises at least one of:
historical link capacity data representative of historical link capacity measurements, or
simulated link capacity data representative of simulated link capacity measurements.

18. The system of claim 11, wherein the link capacity estimate is representative of a prediction of a return link capacity over the wireless communication link, the return link capacity being associated with quantity of data the wireless communication link is estimated to be capable of carrying in a return wireless communication in response to a sent wireless communication between the at least one communication device and at least one remote communication device.

19. The system of claim 11, wherein the at least one wireless communication link characteristic comprises at least one of:
a slant range associated with at least one of the at least one communication device and at least one remote communication device,
a communication device elevation associated with at least one of the at least one communication device and at least one remote communication device, or
a communication device performance associated with at least one of the at least one communication device and at least one remote communication device.

20. The system of claim 19, wherein the communication device performance comprises signal-to-interference-and-noise ratio (SINR).
